(19) United States
(12) Patent Application Publication
(10) Pub. No.: US 2009/0040377 A1
(43) Pub. Date: Feb. 12, 2009

(54) VIDEO PROCESSING APPARATUS AND VIDEO PROCESSING METHOD

(75) Inventors: Makoto Kurahashi, Saitama (JP); Takeshi Nakamura, Saitama (JP); Hajime Miyasato, Saitama (JP)

Correspondence Address: YOUNG & THOMPSON, 209 Madison Street, Suite 500, ALEXANDRIA, VA, 22314, US

(73) Assignee: Pioneer Corporation, Tokyo (JP)

(21) Appl. No.: 11/996,589

(22) PCT Filed: Jun. 19, 2006
(86) PCT No.: PCT/JP2006/312258

§ 371 Date: Jan. 24, 2008

(30) Foreign Application Priority Data
Jul. 27, 2005 (JP) 2005-216671

(51) Int. Cl. H04N 7/00

(52) U.S. Cl. 348/468; 348/E07.001

(57) ABSTRACT

A video processing apparatus performs a subtitle detection process for each frame in a video signal, wherein a two-step edge determining unit performs primary determination of a plurality of small blocks according to a first determination standard associated with edges, and performs a secondary determination of a plurality of large blocks according to a second determination standard associated with the presence of small blocks for which the first determination was satisfied.

### CROSS-REFERENCE TO RELATED APPLICATION

This application is based on Japanese Patent Application No. 2005-216671 filed on Jul. 27, 2005, the contents of which is incorporated hereinto by reference.

### BACKGROUND OF THE INVENTION

1. Field of the Invention

The present invention relates to a video processing apparatus and a video processing method for performing processes for detecting subtitles in video images.

2. Description of the Related Art

In recent years, methods have been commonly used for inserting subtitles into video images as a visual effect for broadcast programs. Subtitles display content to be particularly emphasized or matter thought to be important in a program, using characters, etc., and act as an aid for program viewers to understand the content.

Previous technologies which have been proposed for detecting such subtitles from video signals include, for example, that described in JP, A,10-304247.

The prior art described in JP, A, 10-304247 discloses a video subtitle detection apparatus having a subtitle candidate pixel extracting unit for detecting pixels to be subtitle candidates from input video, a buffer for accumulating the detected subtitle candidate pixels, and a composing unit for combining the subtitle candidates accumulated in the buffer. Thereafter, edge determination is performed by the subtitle candidate pixel extracting unit by projecting an edge image vertically and horizontally and selecting areas in which edge density (projection frequency) exceeds a threshold value as subtitle candidate pixels.

In general, video images are expressed as moving images by displaying a succession of many slightly differing screens, the individual screens constituting the moving images being called frames. Since edges always occur on borders (outside borders) of characters, etc., making up subtitles when a subtitle is present in a screen, edge detection is performed inside a frame when detecting subtitles, and a determination is made as to whether or not detected edges are edges constituting a subtitle (=edge determination).

The prior art described in JP, A,10-304247 performs edge detection and then uses the fact that edge density increases in subtitle portions of video images to make an edge determination. However, since in actuality the larger subtitle characters are, the lower the edge density will be, for subtitles with characters larger than a certain size the edge density is not high enough to distinguish between surrounding areas and subtitles. For this reason, precise edge determination is difficult in cases of subtitles with large characters, resulting in low detection precision for subtitles.

### SUMMARY OF THE INVENTION

It is therefore an object of the present invention to provide a video processing apparatus and a video processing method capable of improving detection precision of subtitles contained in video images.

To achieve this object, the invention described in claim 1 is a video processing apparatus performs a detection process for subtitles in each of frames in a video signal comprising: a multi-step edge determining unit performs multi-step determination associated with edges, while performing determination of a following step using a determination standard different from a determination standard in a case in which a determination for a previous step was satisfied for one of said frames.

To further achieve this object, the invention described in claim 12 is a video processing method performs a detection process for subtitles in each of the frames of a video signal, wherein multi-step determination associated with edges is performed, while performing determination of a following step using a determination standard different from a determination standard in a case in which a determination for a previous step was satisfied for one of said frames.

### BRIEF DESCRIPTION OF THE DRAWINGS

These objects and other objects and advantages of the present invention will become more apparent upon reading of the following detailed description and the accompanying drawings in which:

FIG. 1 is a front view showing an abbreviated external structure of an image recording and playback apparatus to which the present invention is applicable;

FIG. 2 is a functional block diagram showing an overall functional configuration of the image recording and playback apparatus shown in FIG. 1;

FIG. 3 is a functional block diagram showing an overall functional configuration of a video processing apparatus of one embodiment of the present invention;

FIG. 4 is a flowchart showing a processing procedure executed by functional units in the video processing apparatus shown in FIG. 3;

FIG. 5 is a flowchart showing a detailed procedure of step S100 in FIG. 4 executed by a two-step edge determining unit;

FIG. 6 is a descriptive diagram conceptually showing the idea of ordering determination;

FIG. 7 is a flowchart showing a detailed procedure of ordering determination in step S150 in FIG. 5 executed by the two-step edge determining unit;

FIG. 8 is a descriptive diagram approximately showing behavior in an actual specific example of two-step edge determination;

FIG. 9 is a flowchart showing a detailed procedure of step S200 in FIG. 4 executed by a frame subtitle determining unit;

FIG. 10 is a descriptive diagram conceptually showing the idea of flat area detection;

FIG. 11 is a flowchart showing a detailed procedure of step S220 in FIG. 9 executed by the frame subtitle determining unit;

FIG. 12 is a view showing an example of flat area data;

FIG. 13 is a flowchart showing a detailed procedure of subtitle determination in step S240 in FIG. 9 executed by the frame subtitle determining unit;

FIG. 14 is a flowchart showing a detailed procedure of subtitle presence determination in step S260 in FIG. 9 executed by the frame subtitle determining unit;

FIG. 15 is a flowchart showing a detailed procedure of step S100A executed by a two-step edge determining unit in a variation in which ordering determination is not performed;

FIG. 16 is a functional block diagram showing an overall functional configuration of an image recording and playback apparatus according to a variation using data properties according in MPEG format;

FIG. 17 is a functional block diagram showing a detailed functional configuration of an MPEG encoder processing unit and an MPEG decoder processing unit shown in FIG. 18;

FIG. 18 is a functional block diagram showing an overall functional configuration of a video processing device;

FIG. 19 is a flowchart showing a processing procedure executed by functional units in the video processing apparatus shown in FIG. 18; and

FIG. 20 is a flowchart showing a detailed procedure of step S100A in FIG. 19 executed by the two-step edge determining unit.

### DETAILED DESCRIPTION OF THE PREFERRED EMBODIMENTS

The following describes an embodiment of the present invention with reference to accompanying drawings. The present embodiment is an embodiment of a case in which a video processing apparatus according to the present invention is applied to an image recording and playback apparatus constituted so as to be capable of recording and playing back DVDs (a so-called DVD recorder).

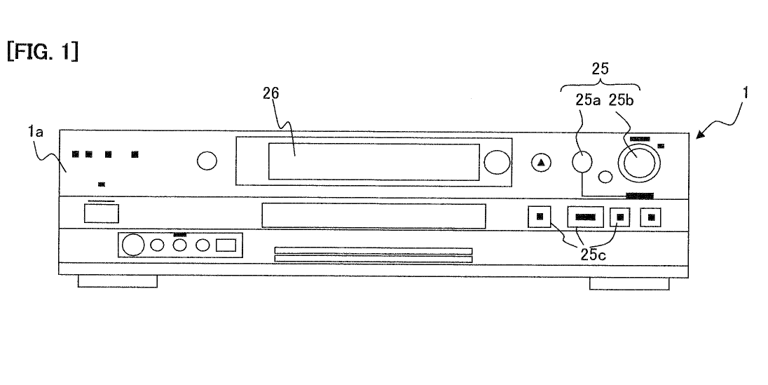

FIG. 1 is a front view showing an abbreviated external structure of the video recording and playback apparatus 1. In FIG. 1, the image recording and playback apparatus 1 has a front panel 1a, and the front panel 1a is provided with an operating unit 25 having function keys, multi-dials, and so on for inputting operating commands, and a display unit 26 made up of liquid crystal, etc., for displaying operating states of the image recording and playback apparatus 1 as text or image data.

The operating unit 25 is provided with a function key 25a for selecting execution modes of the image recording and playback apparatus 1 (for example, recording mode, playback mode, television reception mode, editing mode, etc.), a multi-dial 25b for setting execution statuses executable in the execution mode selected by the function key 25a (for example, volume setting value, recording level setting value, channel setting value, etc.), and operating switches 25c such as playback start, playback stop, and so on.

The display unit 26 displays text data made up of, for example, short phrases in English, katakana, and the like, and/or image data such as signals, graphs, indicators, and the like.

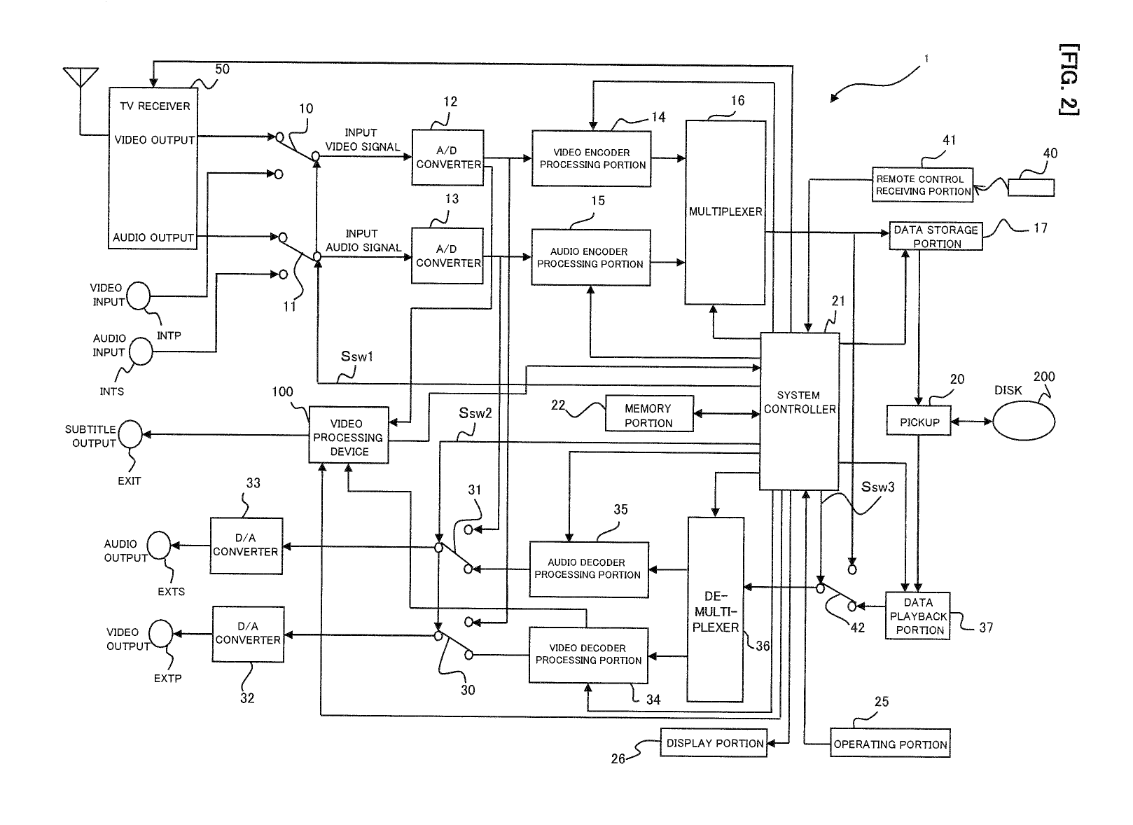

FIG. 2 is a functional block diagram showing an overall functional configuration of the image recording and playback apparatus 1. In FIG. 2 and FIG. 1 mentioned above, the image recording and playback apparatus 1 is broadly functionally divided into a recording apparatus side for recording content data to an optical disc 200, and a playback apparatus side for playing back content from the optical disc (for example, writable DVD-R, DVD-RW, DVD-RAM, and so on) 200, and comprises a system control unit 21 for performing overall control of the image recording and playback apparatus 1, and a video processing unit 100 of the present embodiment for performing subtitle detection.

The recording unit side of the image recording and playback apparatus 1 comprises a television receiver 50 for receiving television signals via an antenna and outputting video signals and audio signals, switches 10 and 11 for switching between video input and audio input from external input pins INTP and INTS and video output and audio output from the television receiver 50 according to a switch control signal Ssw1 from the system control unit 21, A/D converters 12 and 13 for performing A/D conversion of the video signal and audio signal from the switches 10 and 11, a video encoder processing unit 14 and an audio encoder processing unit 15 for encoding the video signal and audio signal from the A/D converters 12 and 13, a multiplexer 16 for multiplexing the encoded video signal and audio signal from the video encoder processing unit 14 and the audio encoder processing unit 15, a data recording unit 17 for supplying the multiplexed signal as a laser light drive signal for writing, and an optical pickup 20 for irradiating the optical disc 200 with laser light for writing data based on the drive signal.

The playback apparatus side of the image recording and playback apparatus 1 comprises the optical pickup 20, shared with the recording apparatus side, for irradiating the optical disc 200 with laser light for data reading, and receiving reflected light or the like from the optical disc 200, a data playback unit 37 for generating a detection signal from the reception output of the optical pickup 20, a de-multiplexer 36 for de-multiplexing the detection signal generated by the data playback unit 37 and outputting a video signal and an audio signal, a video decoder processing unit 34 and an audio decoder processing unit 35 for decoding this video signal and this audio signal, switches 30 and 31 for switching according to a switch control signal Ssw2 from the system control unit 21, a D/A converter 32 for performing D/A conversion of digital output with respect to the video signal from the video decoder processing unit 34 or the A/D converter 12 supplied via the switch 30, a D/A converter 33 for performing D/A conversion with respect to the audio signal from the audio decoder processing unit 35 or the A/D converter 13 supplied via the switch 31, and a remote control receiving unit 41 provided together with the operating unit 25 and display unit 26 to the front panel 1a.

Analog video output and analog audio output via external output pins EXTP and EXTS from the D/A converters 32 and 33 are output from an unshown CRT, plasma display, liquid crystal display, or other display apparatus and a speaker.

A switch 42 can check whether or not video signals and audio signals are being recorded correctly with the video output and audio output by being switched according to a switch control signal Ssw3 from the system control unit 21.

The remote control receiving unit 41 receives command signals from a remote control 40 provided separated from the main apparatus unit, and the received command signals are input to the system control unit 21. Command signals input through the operating unit 25 are also input to the system control unit 21, and overall control of the image recording and playback apparatus 1 is performed according to operating command signals input from the remote control 40 and the operating unit 25, in accordance with computer programs set in advance. A memory unit 22 made up of, for example, RAM or the like for storing various types of data needed for control is connected to the system control unit 21.

In this way, the image recording and playback apparatus 1 can record to the optical disc 200 video signals and audio signals input from the television receiver 50 or the external input pins INTP and INTS, and, further, can output video signals and audio signals recorded on the optical disc 200 via the external output pins EXTP and EXTS.

The video processing apparatus 100 of the present embodiment inputs video signals (video content) input from the external input pin INTP or the television receiver 50 of the video recording apparatus 1 after A/D conversion by the A/D converter (in other words, before encoding by the video encoder processing unit 14), or video signals played back by the optical disc 200 after being decoded by the video decoder processing unit 24, and can detect subtitles included in those input video signals. The video processing apparatus 100 can further input signals related to detected subtitle data to the system control unit 21 and record these signals together with video signals and audio signals to the optical disc 200, and can output these signals directly to the exterior through a subtitle data output pin EXTT.

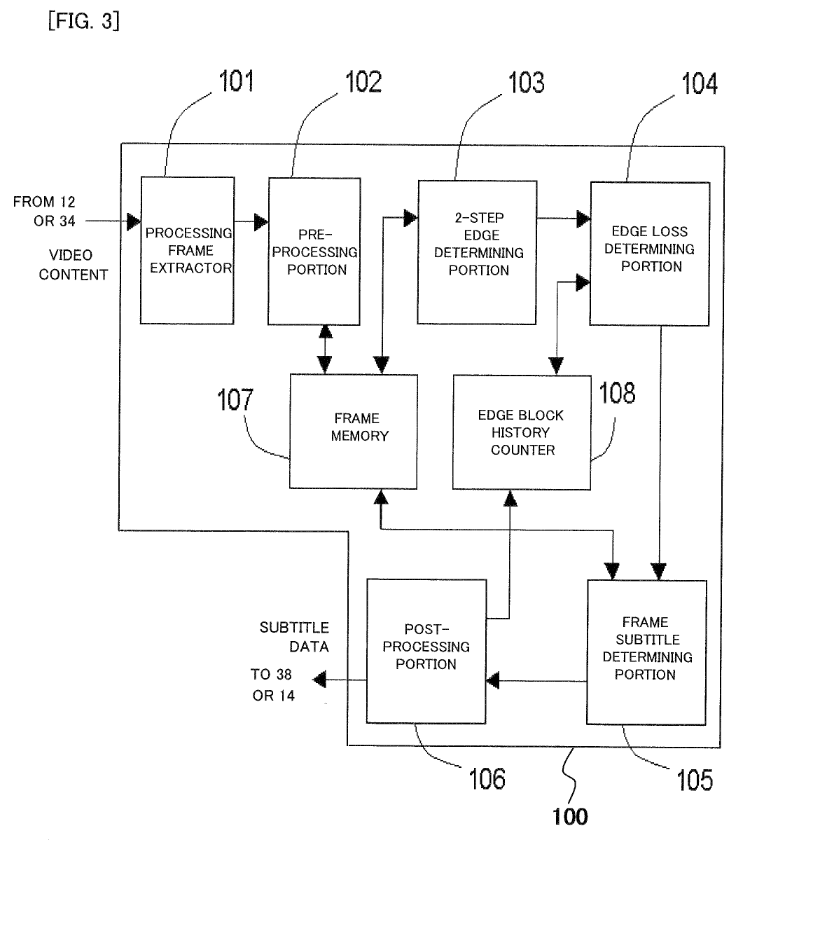

FIG. 3 is a functional block diagram showing an overall functional configuration of the video processing apparatus 100. In FIG. 3, the video processing apparatus (subtitle detecting apparatus) 100 comprises a processing frame extracting unit 101 for inputting video content from the A/D converter 12 or the video decoder processing unit 34 of the video recording apparatus 1, and also extracting frames in sequence from start to finish along a time axis of the video content and output image data from each frame (note that it is possible also to process a few frames at a time, and not all frames of the video source at once), a pre-processing unit 102 for performing edge detection on luminance images as a pre-process for image data extracted by the processing frame extracting unit 101, and creating binarized edge images using threshold values, a frame memory 107 for temporarily holding edge images and/or frame images pre-processed by the pre-processing unit 102 or holding edge images between frames in order to generate still edges, a two-step edge determining unit 103 for performing multi-step (in this example two-step) edge block determination of most recent still edge images and generating edge area rows expressing candidate areas through to be where subtitles are displayed in the current frame (multi-step edge determining unit), an edge loss determining unit 104 for determining whether or not there is a possibility that a subtitle was lost from the preceding frame to the current frame, a frame subtitle determining unit 105 (flatness determining unit) for determining whether or not an area indicating a subtitle area candidate determined by the edge loss determining unit actually included a subtitle in the preceding frame, a post-processing unit 106 for discarding no longer needed data for which processing is finished, and an edge block history counter 108 for holding whether or not a block in a frame was determined to be an edge block in the preceding frame, and for how long it was determined to be an edge block.

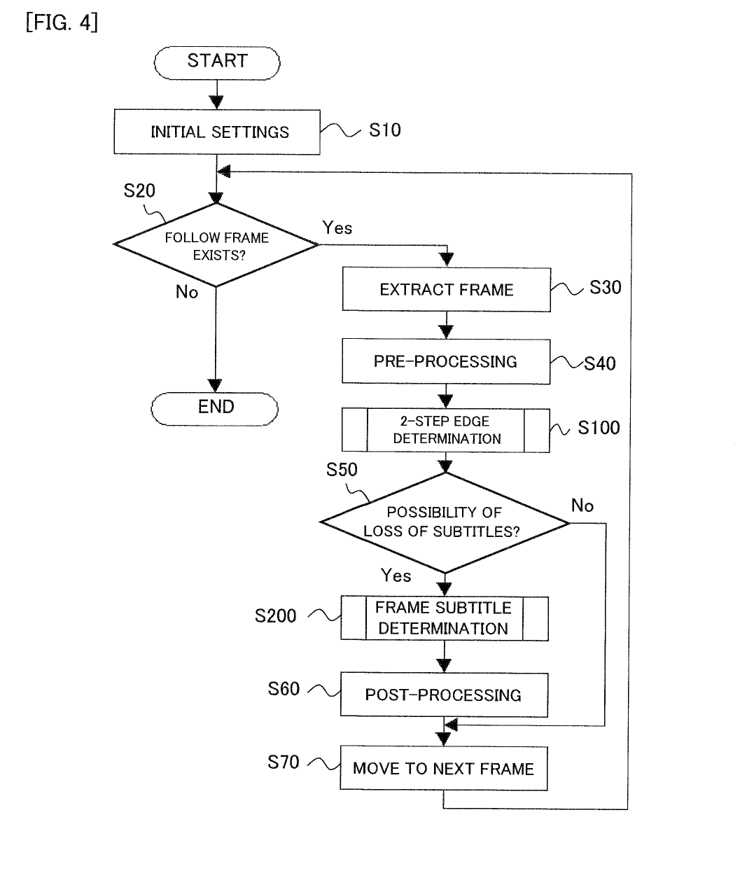

FIG. 4 is a flowchart showing a processing procedure executed by functional units in the video processing apparatus 100 shown in FIG. 3. In FIG. 4, in step S10, first a prescribed initial value (−1 in this example) is substituted in the block elements of the edge block history counter 108, thereby initializing them.

Moving next to step S20, the processing frame extracting unit 101 determines whether or not a following frame is present. This determination is satisfied when input of content from the video recording apparatus 1 begins. The procedure enters the loop from step S30 to step S70, and while the input video content continues, the procedure returns to step S20 from step S70 and repeats the process of this loop. Once the video content from the video recording apparatus 1 side finishes, the determination at stop S20 is no longer satisfied, and the entire process stops.

At step S30, the processing frame extracting unit 101 extracts a frame to be processed next from the video content input as described above, and image data from that frame is output to the pre-processing unit 102. It is preferable that the luminance data in this image data be treatable as YUV format data.

The procedure moves to step S40 after this, and the pre-processing unit 102 extracts edges from the image data of the frame being processed which was extracted and input in step S30. Edge extraction is performed using a publicly known method using Laplacian, Roberts, or other filters on the luminance components. As a result of applying the filter, a binary image is generated in which pixels whose absolute value is equal to or exceeds a threshold value are set to 1 and other pixels are set to 0. This is then saved in frame memory.

At this time, the binarized edge images from past frames processed as described above remain in the frame memory 107, and the pre-processing unit 102 references binarized edge images of frames (the exact number can be set as needed) processed in the past and held in the frame memory 017 (the number of past frames which is referenced can be set as needed). Next, a most recent still edge image is generated in which pixels in which an edge is expressed in all the past binarized edge images (whose values are all 1) are set to 1, and other pixels are set to 0. This generated most recent still edge image is input into and held by the frame memory 107.

Next, the procedure moves to step S100, and edge determination is performed in two steps by the two-step edge determining unit 103. Namely, edge determination in block units is performed using a two-step scale of small blocks and large blocks for still edge images generated in the pre-processing of step S40, and the conformant determination results for large blocks is output as edge area rows.

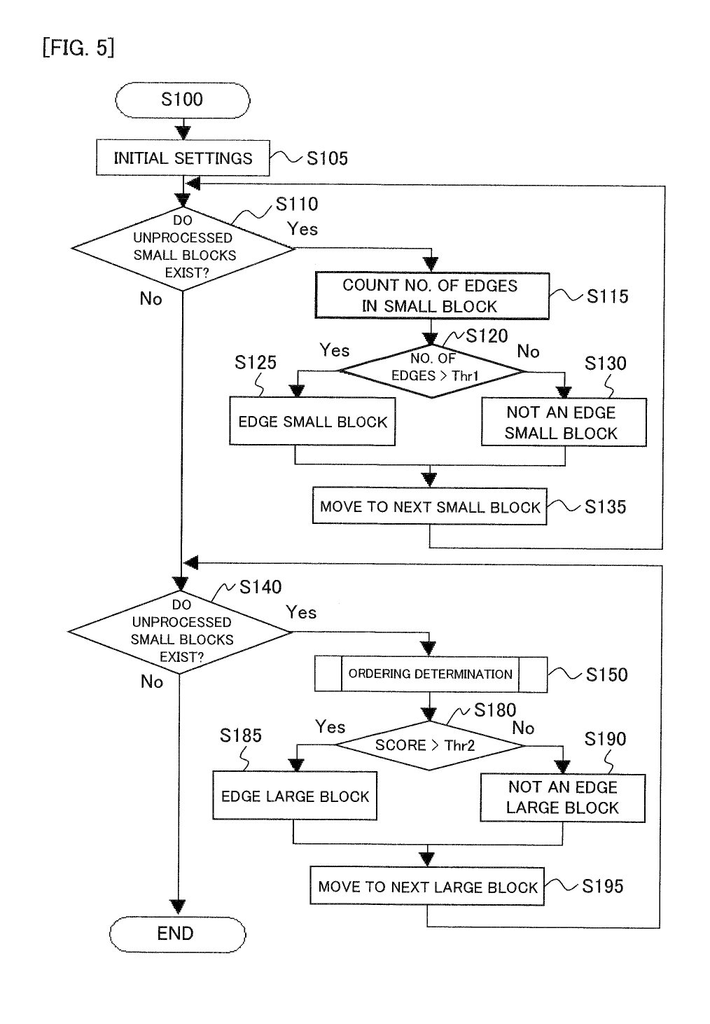

FIG. 5 is a flowchart showing a detailed procedure for step S100 executed by the two-step edge determining unit 103.

In FIG. 5, first, in step S105 the entire image is divided into many small blocks with a size of, for example, 8 pixels by 8 pixels as an initial setting. The large blocks are then set to a size including, for example, 8 small blocks by 8 small blocks=64 blocks. If the size of the small blocks is 8 pixels by 8 pixels, then the size of the large blocks is 64 pixels by 64 pixels. The entire image is divided into such large blocks. There might, however, be cases in which large blocks cannot be fit without gaps (equally divided) into the entire image, depending on the setting of the size of the large blocks. In such cases, the sides of the image may be excluded from subtitle detection, and not made to be included in any large block, or the large blocks may be set so as to partially overlap, such that some small blocks are included in many large blocks.

Edge small block rows for writing the determination results of small blocks and edge area rows for writing the determination results of large blocks are prepared and each element is initialized to 0. The focus position of the small blocks and the large blocks is set to the top left corner of the screen.

Next, the procedure moves to step S110, and a determination is made whether or not there are any unprocessed small blocks present. Since there are unprocessed small blocks present, this determination is satisfied, and procedure enters the loop from step S115 to step S135, and the processes of this loop are repeated, returning from step S135 to step S110, until all the small blocks are processed, and there are no longer any unprocessed small blocks.

In step S115, edge detection is performed in small block units based on the input image. With respect to the small block mentioned above, the number of edges in the small blocks is counted. In other words, the number of pixels with a value of 1 in the still edge image generated in step S40 is counted.

After this, the procedure moves to step S120 and a determination is made whether or not the number of pixels (number of edges) in the small block counted in step S115 is larger than a threshold value Thr1. If the number is larger than the threshold value Thr1, the determination is satisfied, and the small block is deemed to be a small block with many small edges (hereafter called “edge small block” for convenience), and the procedure moves to step S125, and 1 is written to the position of that small block in the edge small block row. If the number is equal to or smaller than the threshold value Thr1, the determination at step S120 is not satisfied, and the procedure moves to step S130, and 0 is written to the position of that small block in the edge small block row. It is sufficient for an appropriate value to be set in advance for the threshold value Thr1.

When step S125 or step S130 is finished, the procedure moves to step S135, the focus is moved to the next small block, then the same procedure returns to step S110 and repeats.

In this way, the loop from step S110 to step S135 is repeated, and the determination in step S110 is satisfied when all small blocks are processed and no unprocessed small blocks remain. The procedure then moves to step S140.

In step S140, a determination is made whether or not any unprocessed large blocks remain. Since there are unprocessed large blocks present, this determination is satisfied, and procedure enters the loop from step S150 to step S195, and the processes of this loop are repeated, returning from step S195 to step S140, until all the large blocks are processed, and there are no longer any unprocessed large blocks.

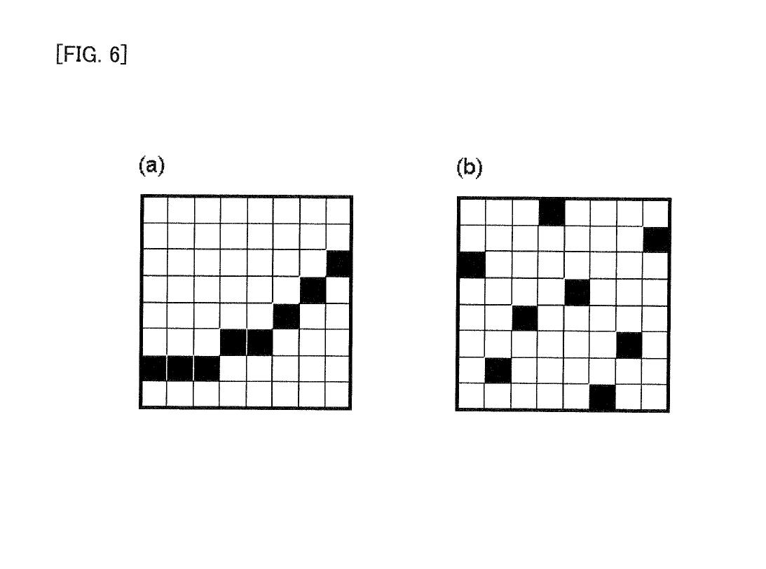

In step S150, based on the edge small block rows, “ordering determination” in large block units is performed. FIG. 6A and FIG. 6B are descriptive diagrams conceptually expressing the idea (determination concept) of ordering determination, and show one large block and many (64 in this example) small blocks therein. The black small blocks indicate edge small blocks mentioned above, and white small blocks indicate other small blocks.

In FIG. 6A and FIG. 6B, the small blocks shown in the drawings each have 8 edge small blocks inside. Therefore, if a determination were made only based on the number of edge small blocks in the large blocks, as was done for the large blocks, then these two would be evaluated the same. However, as is obvious from the drawings, considering the shape of an actual subtitle, in FIG. 6A the edge small blocks are linked in a line, making it likelier that they are part of a subtitle than FIG. 6B in which the edge small blocks are scattered.

Accordingly, “ordering determination” of small blocks is performed, such that large blocks with an aspect such as is shown in FIG. 6A are evaluated higher than large blocks with an aspect such as is shown in FIG. 6B. Specifically, a score is given for a large block's edge small block quality based on the distribution of the edge small blocks inside the large block. In other words, for the small blocks in a large block, higher scores are given if the small blocks are part of a set of edge small blocks linked in a longer line. The total of the scores for the small blocks is the score of the large block.

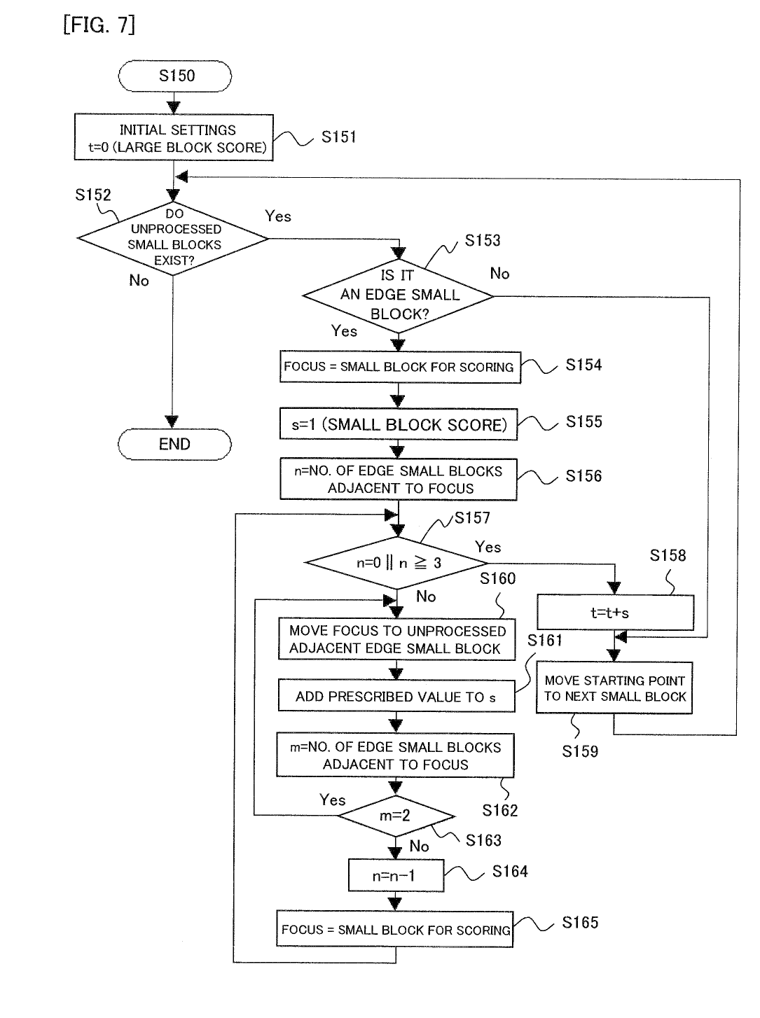

FIG. 7 is a flowchart showing a detailed procedure for the ordering determination of step S150 executed by the two-step edge determining unit 103 based on the above basic principle.

In FIG. 7, at step S151, first a variable t=0 is set (substituted) for storing the score of the large block being determined, as an initial setting. The small block to be evaluated included in the large block is set to the upper left corner of the large block.

Next, the procedure moves to step S152, and a determination is made as to whether or not there are any unprocessed small blocks present. Since there are unprocessed small blocks present, this determination is satisfied, and procedure enters the loop from step S153 to step S165, and the processes of this loop are repeated, returning from step S165 to step S152, until all the small blocks are processed, and there are no longer any unprocessed small blocks.

At step S153, a determination is made the small block being evaluated is an edge small block (whether or not a 1 was written to the position of the small block in the edge small block row in step S125 or step 130). This determination is not satisfied if the small block is not an edge small block, and the procedure moves to step S159 described below, and the evaluation moves to the next small block. However, if it is an edge small block, then the determination is satisfied, and the procedure moves to the next step, step S154.

In step S154, the focus is on the small block being evaluated. Thereafter, the procedure moves to step S155, and the 1 of the initial setting is substituted into variable s for storing the score for the current small block being evaluated.

In step S156, the procedure looks at the 8 blocks surrounding the small block being focused on. The number of edge small blocks among the blocks adjacent to the small block being focused on (8 blocks) is set to n, and n is counted.

Thereafter, in step S157, a determination is made regarding whether or not n counted in step S156 is 0 or is greater than or equal to 3. If it is 0, then there are no edge small blocks adjacent to the edge small block, and if n is greater than or equal to 3, then the edge small block is not deemed as being part of a linear link, and the determination in step S157 is not satisfied, the procedure therefore moving to step S158. The score s is not incremented, the current score s is added to the current stored total t, the focus is moved to the next small block in step S159, and the same procedure is repeated, returning to step S152.

If n is 1 or 2, the determination in step S157 is satisfied, the procedure moves to step S160, and the focus is moved to the adjacent edge small block (if n is 1), or one of the adjacent edge small blocks (if n is 2).

Next, in step S161, it is deemed that one linearly linked block is present, a prescribed value (say, 1) is added to the current score s, and the procedure moves to step S162.

In step S162, the procedure looks at the 8 blocks surrounding the new small block being focused on. The number of edge small blocks among the blocks adjacent to the small block being focused on (8 blocks) is set to m, and m is counted.

Next, in step S163, a determination is made regarding whether or not m counted in step S162 is 2 or not (whether or not the number of adjacent edge small blocks newly focused on is 2, and there is one more adjacent edge small block other than the immediately preceding block that was focused on). If m is 2, the determination is satisfied, and the procedure returns to step S160, and the processes of steps S160 to step S163 are repeated, moving the focus and adding prescribed value to s every time.

If the number of adjacent edge small blocks m is not 2 while repeating these processes, the determination in step S163 is not satisfied, the procedure returns to step S164, 1 is subtracted from n (the number of edge small blocks adjacent to the edge small block being focused on), and in step S165 the focus is returned to the block being evaluated, and the procedure returns to step S157, and the same procedure is repeated.

If n is still 1 at this point, the determination in step S157 is satisfied, and the procedure moves to step S160. The focus is moved to an adjacent edge small block on the side to which the focus was not moved to before, and the same process is repeated thereafter. If n is 0, the determination in step S157 is not satisfied, and as described above, the procedure moves to step S158, the current score s is not incremented, s is added to the current stored value t, and the evaluation moves to the next small block in step S159.

In this way, the loop from step S153 to step S165 is repeated, and the determination in step S152 is not satisfied when all small blocks are processed and no unprocessed small blocks remain. The procedure flow then ends. As a result, a score s is given to all small blocks in the large block being evaluated, the total of the score s for each small block is sequentially added up, and the ordering determination process in which the stored value t, which is the final sum, is set as the score for the large block.

Returning to FIG. 5, and if the ordering determination is finished as above, the procedure moves to step S180. In step S180, a determination is made as to whether or not the score (stored value) t calculated in the ordering determination in step S150 is larger than the threshold value Thr2. If it is larger than the threshold value Thr2, the determination is satisfied, and it is deemed that the large block is an edge large block the state of whose internal edges appears to indicate a subtitle (the possibility of being a subtitle is relatively high). The procedure moves to step S185, and 1 is written to the position of that block in the edge area row. If it is equal to or smaller than the threshold value Thr2, the determination at step S180 is not satisfied, and the procedure moves to step S190, and 0 is written to the position of that large block in the edge area row. It is sufficient for an appropriate value to be set in advance for the threshold value Thr2.

When step S185 or step S190 is finished, the procedure moves to step S195, the focus is moved to the next large block, then the same procedure returns to step S140 and repeats.

In this way, the loop from step S140 to step S195 is repeated, and the determination in step S140 is no longer satisfied when all large blocks are processed and no unprocessed large blocks remain. The two-step edge determination process then ends.

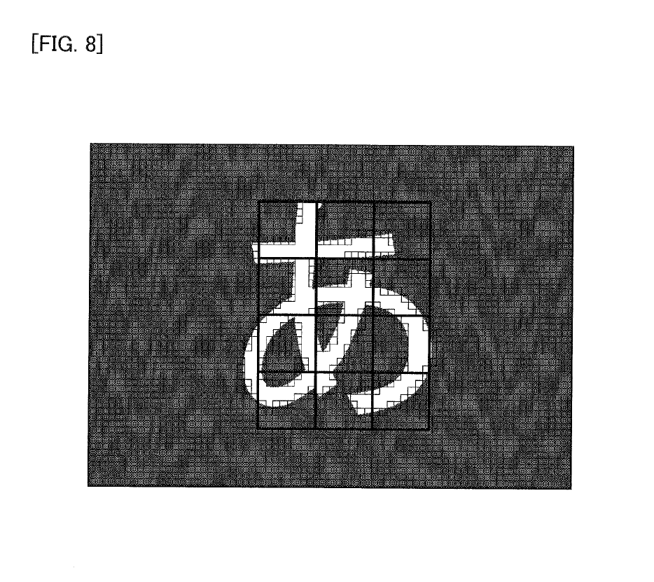

FIG. 8 is a descriptive diagram approximately showing behavior when two-step edge determination is performed on a screen in which a relative large Japanese character equivalent to “A” is displayed, as an actual specific example of the two-step edge determination described above. As described above, the entire image (the entirety including portions indicated by approximately being filled in black in FIG. 8) is divided up into many small blocks, and a determination is made as to whether or not many edges are present in those blocks, but in this example, the small blocks on the circumference of the character (indicated by small squares in FIG. 8) are edge small blocks including many edges. Next, a determination is performed on large blocks of a size including these many small blocks (8×8=64 in this example) based on the determination results for these small blocks, but in this example, it is the edge large block (with a relatively high ratio of edge small blocks) including at least the required number of edge small blocks that is shown by the large square in FIG. 8.

Returning to FIG. 4, once the two-step edge determination in step S100 described above is finished, the procedure moves to step S50. In step S50, the edge loss determining unit 104 determines whether or not there is a possibility that a subtitle has been lost from the previous frame to the current frame, based on the status of an area which had contained an edge area in the previously processed frame but which no longer contains an edge area in the current frame. This determination determines, for example, whether or not the number of large blocks which were edge large blocks in the previous frame but are no longer edge large blocks in the current frame is equal to or larger than a prescribed threshold value.

If it is lower than the threshold value, the determination in step S50 is not satisfied, the process moves to step S70, moving to the next frame, and the procedure returns to step S20 and repeats. If it is above the threshold value, the determination in step S50 is satisfied, it is deemed that there is a possibility of a subtitle, the lost edge large block row is output to the frame subtitle determining unit 105 as a subtitle area candidate, and the procedure moves to step S200.

For large blocks which had not been edge large blocks in the previous frame and then became edge large blocks in the current frame, the current frame number is stored in the edge block history counter 108 as a subtitle display start time. The value of the edge block history counter 108 is updated depending on the results of the edge area determination for each block and the current edge block history counter 108 value.

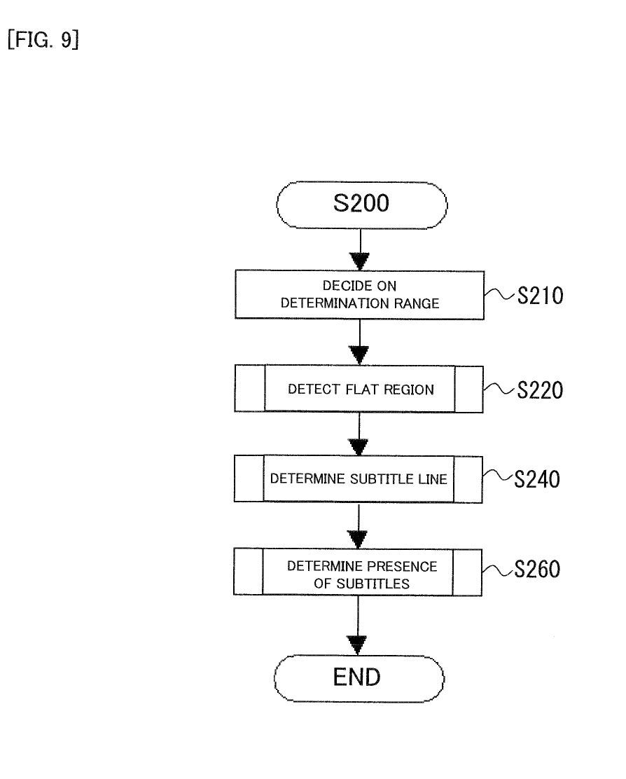

In step S200, a frame subtitle determination is performed for determining whether or not a subtitle is displayed in a certain frame. FIG. 9 is a flowchart showing a detailed procedure for step S200 executed by frame subtitle determining portion 105.

In FIG. 9, in step S210, first a determination range decision is made for deciding the area to be covered for the frame subtitle determination in units of lines of pixels in the edge large block, based on the detection results of the edge large block in the two-step edge determination in step S100. Here, the area on which the edge large block detected by the two-step edge determination is present along a straight horizontal line for a certain number is to be processed by a flatness determination. Moreover, in this example, only horizontal lines are processed, but the same process may be done vertically.

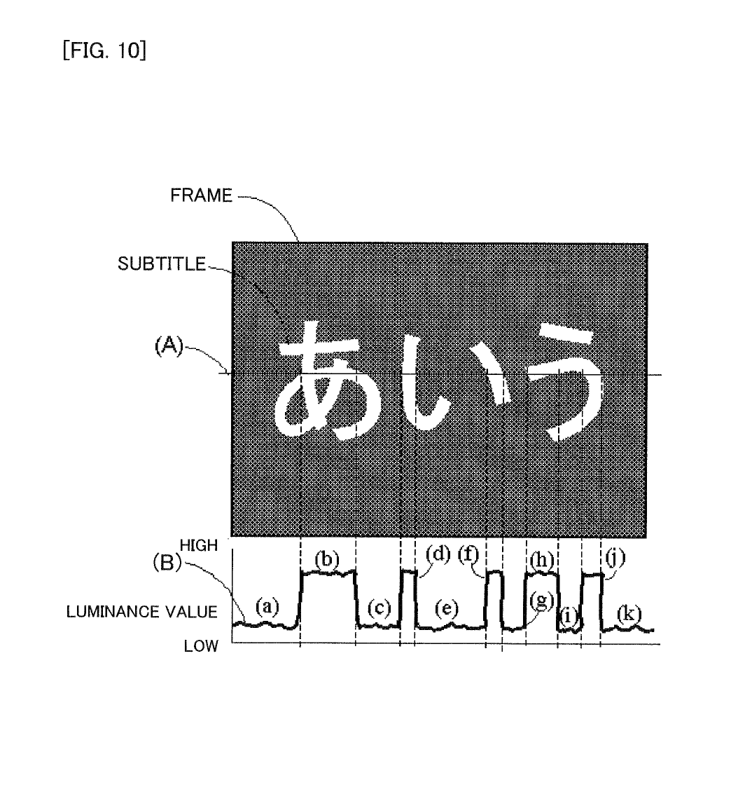

Thereafter, the procedure moves to step S220, and flat area detection is performed for detected areas in which pixels with similar luminance values are grouped in the pixel line as a flat area. FIG. 10 is a descriptive diagram conceptually showing the idea (basic principle) of flat area detection.

In FIG. 10, in this example, a subtitle saying “AIU” in a single bright color is displayed on a dark single-color background. As an example, the line (A) of pixels covering these characters is focused on, and if the luminance values of the pixels in this line are graphed, the result is (B), with five areas of flat luminance arising following the shape of the characters: (b), (d), (f), (h), and (j). Since the background aside from the characters is a uniform color, six parts of the background are also flat: (a), (c), (e), (g), (i), and (k). In this way, areas in which luminance is flat in a line of pixels are extracted from the various lines as flat areas.

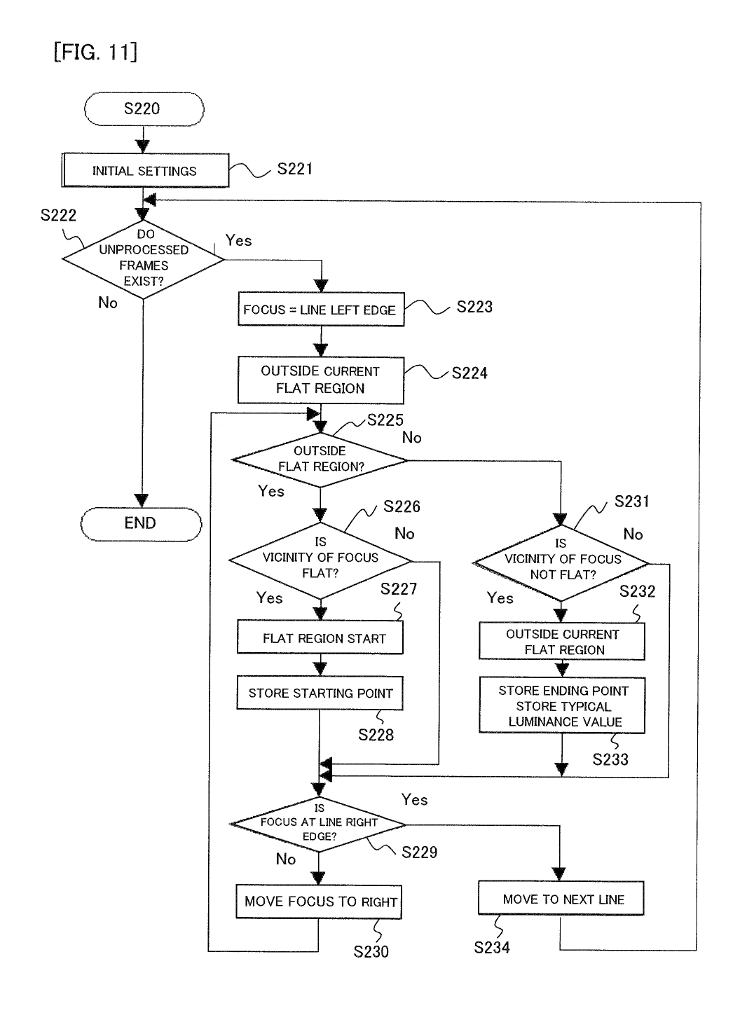

FIG. 11 is a flowchart showing a detailed procedure for flat area detection in step S200 executed by the frame subtitle determining portion 105.

In FIG. 11, prescribed initial settings are made in step S221. For example, the line for determination is set to the topmost line.

Next, the procedure moves to step S222, and a determination is made as to whether or not there are any unprocessed lines present. Since there are unprocessed lines present, this determination is satisfied, and procedure enters the loop from step S223 to step S234, and the processes of this loop are repeated, returning from step S234 to step S222, until all the lines are processed, and there are no longer any unprocessed lines.

In step S223, the focus is first set to the left side of the line. Thereafter, the process moves to step S224, and the current state is set to “non-flat area” as an initial setting for each line determination. Thereafter, the procedure moves to step S225.

In step S225, a determination is made as to whether or not the current state is non-flat area. Since it they were all set to non-flat area in step S224 at first, this determination is satisfied, and the procedure moves to step S226.

In step S226, a determination is made as to whether or not the vicinity of the pixel currently focused on is flat. For a determination of flatness, it is sufficient for the dispersion of the luminance values in a pixel range of a prescribed width around the focused pixel to be equal to or lower than a prescribed value. Alternatively, it may be sufficient for the difference between the maximum and minimum luminance values in the range of the prescribed width to be equal to or lower than a prescribed value for a determination of flatness. If the vicinity of the pixel being focused on is not flat, then the determination is not satisfied, and the procedure moves to step S229, described below.

If the vicinity of the pixel being focused on is flat, the determination in step S226 is satisfied, the currently focused-on pixel is deemed to be a starting point of a flat area, the procedures moves to step S227, the status is set to “flat area,” and then in step S228 the position is stored as the starting point of a flat area, and the procedure moves to step S229.

In step S225, if the current state is flat area, the determination is not satisfied, the procedure moves to step S231, and a determination is made as to whether or not the vicinity of the pixel currently being focused on is not flat. The determination method may be the same method used in step S226. If the vicinity of the pixel being focused on is flat, then the determination is not satisfied, and the procedure moves to step S229, described below.

If the vicinity of the pixel being focused on is not flat, the determination in step S231 is satisfied, the current focused-on pixel is deemed to be an ending point of the flat area, the procedure moves to step S232, the state is set as non-flat area, in step S233 the position is stored as the ending point of the flat area, the average value of the luminance of the pixels included in the now-ended flat area is extracted and stored as a typical luminance value of the flat area, and the procedure moves to step S229.

In step S229, a determination is made as to whether or not the focus state is at the right end. At first, the right end has not been reached, and therefore this determination is not satisfied, the focus is moved one pixel to the right, the procedure returns to step S225, and the same procedure is repeated.

In this way, the process continues, moving the focus to the right one pixel at a time until the focus reaches the right end of a line, starting points of flat areas in a line being stored, ending points being stored, and typical luminance values being calculated and stored. Once the focus reaches the right end of a line, the determination in step S229 is satisfied, the procedure moves to step S234, the focus is moved to the next line, the procedure moves to step S222, and the same procedure is repeated.

In this way, the loop from step S222 to step S234 is repeated, and the determination in step S222 is not satisfied when all lines are processed and no unprocessed lines remain. The procedure flow then ends. As a result, for the number of areas of flat luminance included in all lines being processed, flat area data is generated which is made up of the starting points, ending points, and typical luminance values of all those areas.

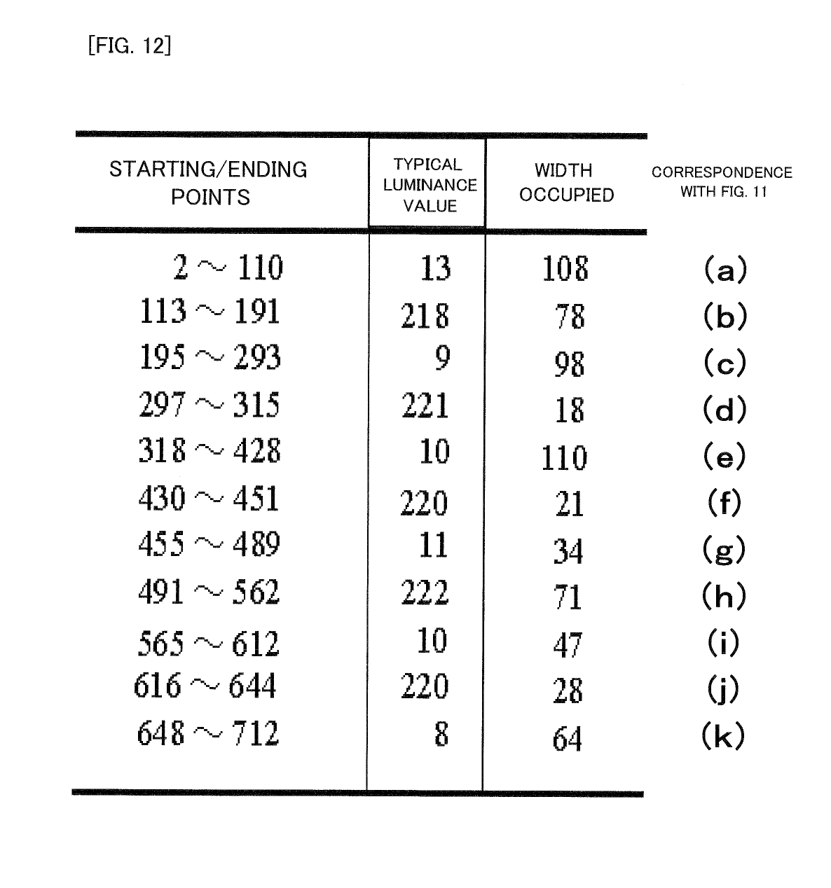

FIG. 12 shows one example of such flat area data. In this example, data is shown for the flat areas corresponding to (a), (b), (c), (d), (e), (f), (g), (h), (i), (j), and (k) in FIG. 10, corresponding to FIG. 10 described above.

Moreover, when detecting flat areas as described above, both sides of an area are checked for occurrences of sharp increases or decreases in luminance corresponding to edges, and it is possible to make that flat area valid only if such occurrences are present. It is also possible to make flat areas with slight variations in luminance values more easily detectable by placing a noise removal filter on tows of luminance values of this line before performing the flat area determination process.

Returning to FIG. 9, once the flat area detection process of step S220 is complete, the procedure moves to step S240, and subtitle line determination is performed for determining whether or not it appears that a line contains a subtitle based on the state of appearance of flat areas, for each line for which flatness detection was performed in step S220.

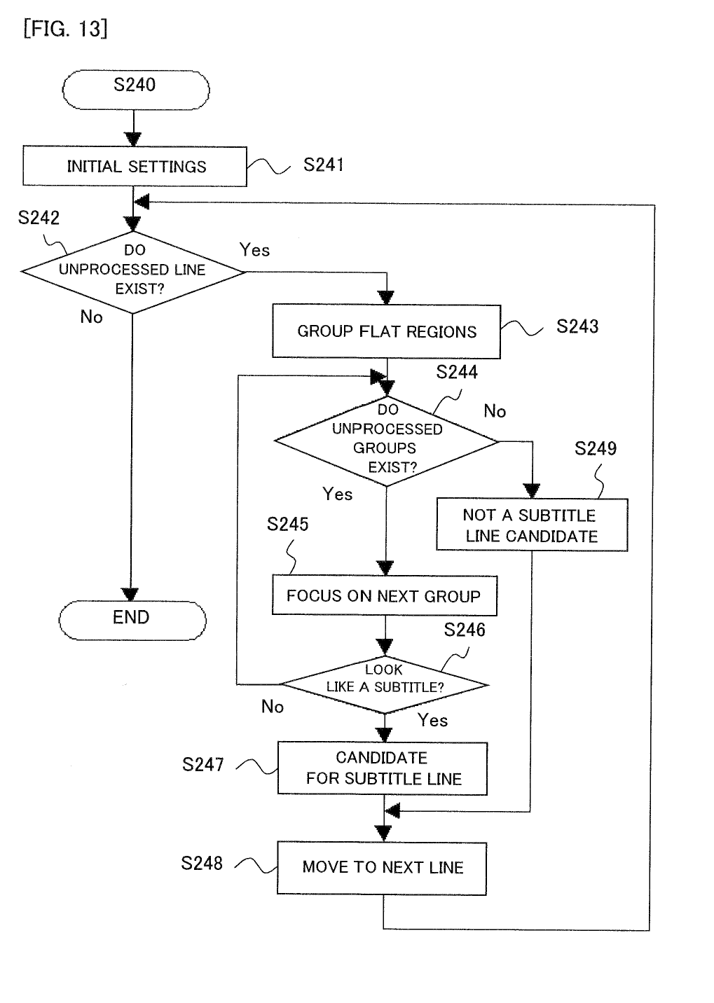

FIG. 13 is a flowchart showing a detailed procedure for subtitle line determination in step S240 executed by the frame subtitle determining portion 105.

In FIG. 13, in step S241, first, prescribed initial settings are made, for example, setting the processing start line to the top line. Next, the procedure moves to step S242, and a determination is made as to whether or not there are any unprocessed lines present. Since there are unprocessed lines present, this determination is satisfied, and procedure enters the loop from step S243 to step S249, and the processes of this loop are repeated, returning from step S248 to step S242, until all the lines are processed, and there are no longer any unprocessed lines.

In step S243, flat areas detected in a line are grouped according to the nearness of their typical luminance values. It is sufficient for the setting of the nearness of the typical luminance values at this time to set an appropriate range according to an aspect of the content or use of the operator.

Thereafter, the procedure moves to step S244, and a determination is made as to whether or not unprocessed groups are present. Since all the groups grouped in step S243 are unprocessed initially, this determination is satisfied, and the procedure moves to step S245.

In step S245, each group is focused on and “subtitle-ness” is determined (i.e., whether or not the probability of a subtitle is relatively high). Determination conditions for this determination are based on the number of flat areas and width occupied, etc., for example, the width occupied by the flat area of the group on the line being within a set range, the number of flat areas being at least a set number, etc. Adjustment of a width condition is also possible depending on the number of flat areas. A position of a flat area may also be used as a condition. For example, if there is an area beginning at the left end of the screen and the right end of the screen, there is a high probability that that group is background, rather than a subtitle. Therefore, it is possible to ensure that that line is not determined to be a subtitle line candidate, by using that group.

If a line lacks “subtitle-ness” (i.e., the probability that it is a subtitle is relatively low), the determination in step S246 is not satisfied, the procedure returns to step S244 and repeats, and the procedure moves to the determination of the next flat area group. If, when repeating step S244->step S245->step S246, no flat area group taken up has “subtitle-ness” and then there are no unprocessed groups are left, the determination in step S244 is no longer satisfied, and the procedure moves to step S249, determines that that line is not a subtitle line candidate, moves to step S248, moves the focus to the next line, returns to step S242, and repeats.

If the line has “subtitle-ness” (i.e., the probability of a subtitle is relatively high), the determination in step S246 is satisfied, the procedure moves to step S247, that line is set as a subtitle line candidate, the procedure moves to step S248, moves to the next line, returns to step S242, and repeats.

In this way, the loop from step S242 to step S249 is repeated, and the determination in step S242 is not satisfied when all lines are processed and no unprocessed lines remain. The procedure flow then ends. As a result, the “subtitle-ness” of flat area groups included in all processed lines is determined, and the setting of subtitle line candidates is finished.

Returning to FIG. 9, once the subtitle line determination process of step S240 is completed as described above, the procedure moves to step S260, and a subtitle presence determination is performed for determining whether or not a subtitle is displayed in the frame based on the state of the subtitle line candidates set in step S240.

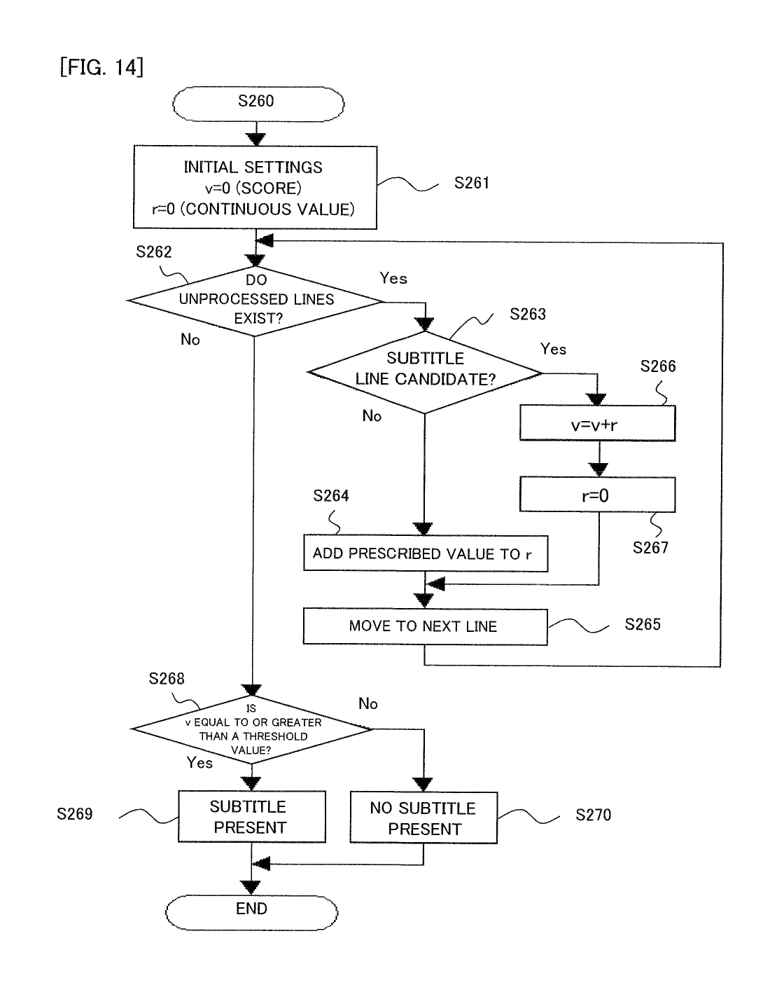

FIG. 14 is a flowchart showing a detailed procedure for subtitle line presence determination in step S260 executed by the frame subtitle determining unit 105.

In FIG. 14, in step S261, first, prescribed initial settings are made, and a variable v for evaluating the presence of subtitles in a frame and a variable r for counting the succession of subtitle line candidates are set to a default value of 0 (0 is substituted in). The processing start line is set, for example, to the top line.

Next, the procedure moves to step S262, and a determination is made as to whether or not there are any unprocessed lines present. Since there are unprocessed lines present, this determination is satisfied, and procedure enters the loop from step S263 to step S267, and the processes of this loop are repeated, returning from step S265 to step S262, until all the lines are processed, and there are no longer any unprocessed lines.

In step S263, a determination is made as to whether or not the line currently being focused on is a subtitle line candidate set in step S240. If it is a tile line candidate, the determination in step S263 is satisfied, a prescribed value (1, for example) is added to the variable r for counting the succession of subtitle line candidates in step S264, and the procedure moves to step S265.

If the line currently being focused on is not a subtitle line candidate, the determination in step S263 is not satisfied, the succession of subtitle line candidates is deemed to have been interrupted, the procedure moves to step S266, the current r reflecting the state of succession until no is added to v, creating a new v. R is initialized to 0 in step S267 in preparation for a new count, and the procedure moves to step S265.

In step S265, the focus moves to the next line, and the procedure returns to step S262 and repeats. In this way, the loop from step S262 to step S267 is repeated, and the determination in step S262 is not satisfied when all lines are processed and no unprocessed lines remain. The procedure then moves to step S268.

In step S268, a determination as to whether or not the score v which is the sum of the variable r counting the succession of the subtitle line candidates is equal to or greater than a prescribed threshold value. If it is equal to or greater than the threshold value, the determination is satisfied, and it is deemed that a subtitle is present in the frame. In step S269 corresponding subtitle display data is generated and saved in the frame memory 107, and is output to the post-processing unit 106. The procedure flow then ends. On the other hand, if it is lower than the threshold value, the determination is not satisfied, no subtitle is deemed to be present in the frame, and the procedure flow ends.

Returning to FIG. 4, once the frame subtitle determination is completed as described above, the procedure returns to step S60, and post-processing of all the processes up till now is performed by the post-processing unit 106. For example, if a subtitle is detected by a frame subtitle determination in step S200 and subtitle display data remains in the frame memory 107, the frame number in which the subtitle is present is calculated using the value in the edge block history counter of the area in which the subtitle was detected. A subtitle display starting frame number, lost frames (the current frame number), and the display position of the subtitle are output to the external output pin EXTT or the system control unit 21 described above as subtitle data signal.

Further, the value in the edge block history counter 108 for the area in which the edge large block was lost is initialized. Images of previous frames and edge image data saved in the frame memory 107 and no longer needed as the current frame has finished being processed are discarded along with the subtitle display data for the current frame.

Once step S60 is complete, the procedure moves to step S70, moves to the next frame, returns to step S20, and repeats.

In the above, step S105 in a control flow executed by the two-step edge determining unit 103 shown in FIG. 5 corresponds to the division setting unit described in the claims for dividing a single frame into a plurality of large blocks, and dividing the large blocks into a plurality of small blocks. Further, step S110 to step S135 corresponds to a primary determining unit for performing primary determination according to a first determination standard relating to edges, and also corresponds to a first determining unit for performing a first determination. Further, step S140 to step S195 corresponds to a secondary determining unit for performing secondary determination corresponding to a second determination standard relating to the presence of small blocks in which the determination by the primary determining unit has been satisfied, and corresponds to a second determining unit for performing a second determination.

Step S243 shown in the procedure flow shown in FIG. 13 executed by the frame subtitle determining unit 105 corresponds to the grouping unit for grouping a plurality of flat areas included in a single frame according to the nearness of the typical luminance values.

The following advantageous effect is obtained by the present embodiment constituted as described above.

Namely, with the video processing apparatus 100 of the present embodiment, edge detection is first performed in preprocessing executed by the pre-processing unit 102 in subtitle detection, in response to the occurrence of edges in borders (outside borders) of characters, etc., making up subtitles when subtitles are present in frames, then a determination is made as to whether or not the detected edges constitute a subtitle. During the edge determination, the two-step edge determining unit 103 performs a determination relating to edges according to different determination standards (in the example, whether or not small blocks are edge small blocks, and whether or not large blocks containing edge small blocks are edge large blocks) in a plurality of steps (2 in this example).

Thereby, when determining and considering the possibility of a subtitle based on the detected edges described above, in this example, in the first step (in this example, a step for determining whether or not a small block is an edge small block) a determination is made roughly according to edges included in a frame (in this example, making a determining of an edge small block based on places where edges are locally collected, as with border of characters). Thereafter, for determinations which have been satisfied, other narrower standards are used (in this example, whether or not a large block containing edge small blocks is an edge large block). Thus, edge determination with great depth can be performed, thereby making it possible to perform edge determination with great precision. As a result, it is possible to perform subtitle detection in video with accurate and high precision (i.e., to detect areas with greater “subtitle-ness”), by improving the precision of the edge detection itself, without raising the subtitle detection precision by, for example, adding data related to determination elements other than edges.

In particular with the present embodiment, if, when an edge is detected, that edge constitutes a subtitle, the ordering determination described above is performed during determination of the next step by the two-step edge determining unit 103 in response to the fact that edges are substantially linearly continuous along the shape of borders (outside borders) of characters, etc., making up a subtitle, And determination is performed according to the substantially linear continuity of the positions at which are present edge small blocks for which the determination of the first step is performed and which are present in large blocks for which determination is being performed.

By performing a determination as to whether or not a large block is an edge large block according to the ordering of the edge small blocks in this way, it is possible to realize edge determination with accurate and high precision compared to performing uniform determination without considering the distribution of edges. In particular, this is especially effective, since it is possible to reduce misdetection of areas other than subtitles such as, for example, when attempting to detect subtitles with relatively few edges, including subtitles with large characters, unlike the prior art in which edge determinations involve a determination made in only one step simply based on the size of the edge density.

In other words, since subtitles in which the characters are not so large tend to have a higher edge density in edges on borders of characters, where edges are relatively dense, than areas other than subtitles, detecting subtitles based solely on the edge density is sufficiently effective. However, if subtitle characters are large, edges are less dense compared to subtitles with small characters, making it difficult to make detections based solely on edge density. If one were to attempt to detect them, however, it would be necessary to make the edge density threshold value for detection low, increasing the likelihood of misdetection, as the distinction with non-subtitle areas would be more difficult.

This embodiment focuses on the nature of subtitles with large characters, in which edges occur near each other to a certain extent along borders of subtitles, and not totally randomly, however low the overall edge density may be. In other words, for example, when detecting edges in small blocks, edge small blocks are recognized by performing determination using a threshold for edge amount (or edge density) which is not small, as usual, and then performing the ordering determination described above for large blocks containing edge small blocks, and then performing a determination according to the approximate linear continuity of the positions at which are present edge small blocks for which the determination of the first step described above is satisfied, and which are present in large blocks for which determination is being performed. It is thus possible to perform accurate subtitle detection while preventing misdetections.

Further, in particular with the present embodiment, flat areas in which pixels with substantially equal luminance or color difference compared to the vicinity in a single frame are detected by the frame subtitle determining unit 105, and a determination is further performed based on this, in addition to the edge determination by the two-step edge determining unit 103 described above, based on the fact that the inner side of borders (outside borders) of characters, etc., constituting subtitles when subtitles are present in frames are ordinarily areas in which pixels with uniform luminance or color difference are continuous. In particular, by detecting flat areas included in lines in the image, and not just whether or not one particular point is flat with respect to its vicinity, it is possible to performing a determination as to whether or not that area is a subtitle with greater precision, based on the distribution of flat areas. This is particularly effective for subtitles with large characters, since the appearance of flat areas is particularly prominent.

Furthermore, in particular with the present embodiment, in light of the fact that, like subtitles, backgrounds are also areas in which pixels with uniform luminance or color difference are continuous, first, in step S245, the frame subtitle determining unit 105 groups flat areas according to the nearness of their typical luminance value. Since the luminance values of subtitles and backgrounds ordinarily differ greatly, the result of this grouping is that flat areas constituting a subtitle are grouped together (for example, (b), (d), (f), (h), and (j) in the example in FIG. 10), and flat areas constituting the background are grouped together (for example, (a), (c), (e), (g), and (k) in the example in FIG. 10). By performing a determination thereafter according to characteristic values in step S245 and step S246 for each group with the frame subtitle determining unit 105, it is possible to distinguish between and thereby recognize flat area groups constituting subtitles and flat area groups constituting backgrounds. It is therefore possible to perform high-precision subtitle detection by removing the background.

Aside from the above, the present embodiment has the effect of making it possible to detect the position at which a frame is displayed within an entire screen.

Note that the present invention is not limited to the above embodiment, and many variations are possible without departing from the scope and technical concept thereof. Such variations are described in order below.

(1) Not Performing Ordering Determination

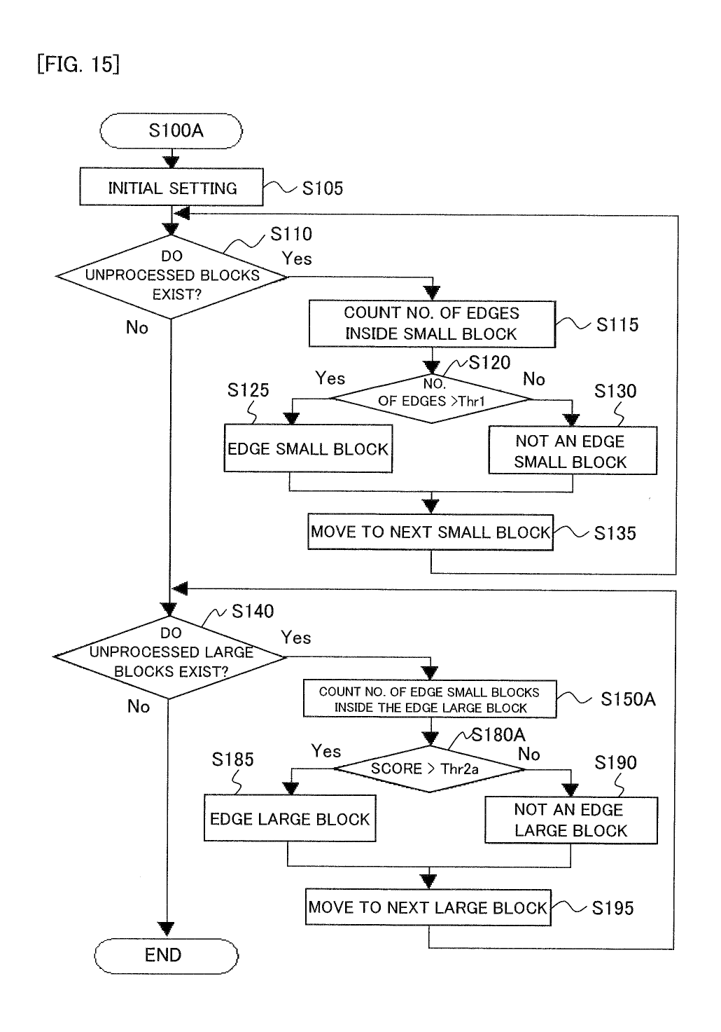

Specifically, it is possible to omit the ordering determination described above in step S150 in FIG. 5, as it is not necessarily required. FIG. 15 is a flowchart showing a detailed procedure of step S100A corresponding to step S100 in the embodiment described above, executed by the two-step edge determining unit 103 in this variation. The same reference numerals are given to the same procedures in FIG. 5, and the description is abbreviated or omitted as appropriate.

In FIG. 15, the difference with FIG. 5 described above is in the face that step S150A and step S180A are provided in lieu of step S150 and step S180. In other words, step S106, step S110, step S115 to step S135, and step S140 are the same as in FIG. 5, but when the determination in step S140 is satisfied, the procedure moves to step S150A.

In step S150A, the number of small blocks determined to be edge small blocks in step S125 in the large block being processed is counted. After this, the procedure moves to step S180A and a determination is made as to whether or not the number of edge small blocks counted in step S150A is larger than a threshold value Thr2a. If it is larger than the threshold value Thr2a, the determination is satisfied, the large block is deemed to be an edge large block with relatively many edge small blocks (this may be two to three, etc., as there is no need for many more than small blocks which are not edge small blocks; it may even be only one more), and the procedure moves to step S185, as in FIG. 5. On the other hand, if this number is equal to or lower than the threshold value Thr2a, the determination in step S180A is not satisfied, the large block is not deemed to be an edge large block, and the procedure moves to step S190, as in FIG. 5. It is sufficient for an appropriate value to be set in advance for the threshold value Thr2a.

The rest of the procedure is the same as the embodiment above, so the description is omitted. In the present variation, step S140 to step S195 of a control flow executed by the two-step edge determining unit 103 shown in FIG. 15 correspond to the secondary determining unit for performing a secondary determination according to a second determination standard (number of edge small blocks in a large block) relating to a the present of small blocks for which a determination by the primary determining unit was satisfied, with regard to a plurality of large blocks, described in the claims, and correspond to a second determining unit for performing a second determination.

In the present embodiment, too, as in the above embodiment, an effect is obtained of improving detection precision in edge determination by performing determination using different determination standards in a plurality of steps. Specifically, edge determination with greater precision can be performed by first determining small blocks in which edges are collected locally as edge small blocks in a first step, and then performing a determination by narrowing to whether or not large blocks containing edge small blocks are edge large blocks.

In particular, since it is possible to reduce misdetections of non-subtitle areas when attempting to detect subtitles in which, for example, edges are relatively few, including cases of subtitles with large characters, this is particularly effective. Specifically, for example, during edge detection in small blocks, edge small blocks are recognized by performing determination at a threshold value for an edge amount (or edge density) which is not high, as normal, on the other hand a relatively small value may be used for the threshold value for the number (or ratio) of edge small blocks, which is how many edge small blocks are present in each large block. This way, it is possible detect subtitles with accuracy and without missing any, since the edge small block number threshold value is low, while also reducing the number of misdetections compared to performing determination of density simply using a low threshold value, since the edge amount threshold value is higher.

Aside from this, the same effects as in the above embodiment are obtained with this variation, as regards effects other than the effects obtained from performing ordering determination.

(2) Using Data Characteristics in MPEG Format

In the present variation, when the input video is encoded in MPEG, subtitle detection is performed using the encoding parameters. The same reference numerals are given to the same procedures in the above embodiment, and the description is abbreviated or omitted as appropriate.

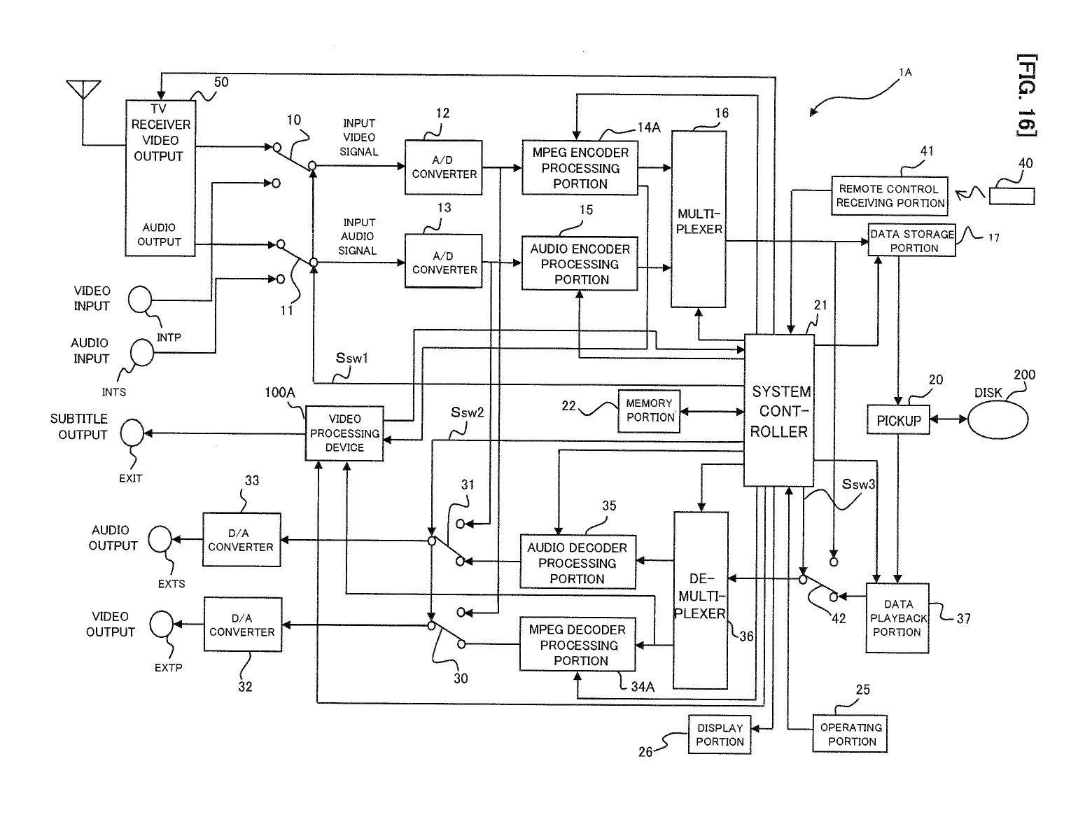

FIG. 16 is a functional block diagram showing an overall functional configuration of an image recording and playback apparatus 1A according to the present variation, and corresponds to FIG. 2 of the above embodiment. In FIG. 16, the image recording and playback apparatus 1A comprises an MPEG encoder processing unit 14A and an MPEG decoder processing unit 34A in lieu of the video encoder processing unit 14 and the video decoder processing unit 34 of the video recording and playback apparatus 1 described above, and comprises a video processing apparatus 100A in lieu of the video processing apparatus 100 described above.

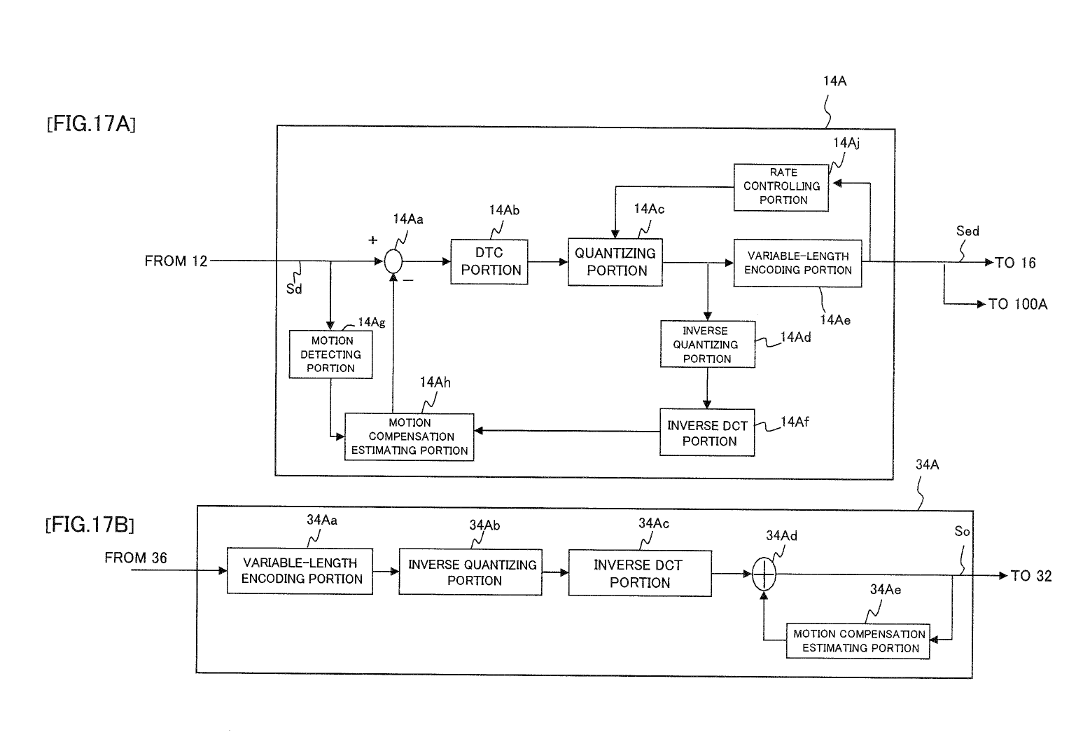

FIG. 17A is a functional block diagram showing a detailed functional configuration of the MPEG encoder processing unit 14A, and FIG. 17B is a functional block diagram showing a detailed functional configuration of the MPEG decoder processing unit 34A.

In FIG. 17A, the MPEG encoder processing unit 14A is configured by an adder 14Aa, a DCT (discrete cosine transform) unit 14Ab, a quantizing unit 14Ac, an inverse quantizing unit 14Ad, a variable-length encoding unit 14Ae, an inverse DCT unit 14Af, a motion detecting unit 14Ag, a motion compensation predicting unit 14Ah, and a rate control unit 14Aj. When a digital data signal Sd is input from the A/D converter 12 shown in FIG. 16, it is compressed in compliance with the MPEG format based on the control signal output from the system control unit 21, and an encoded signal Sed is generated and output to the multiplexer 16.

In FIG. 17B, the MPEG decoder processing unit 34A is constituted by a variable-length decoding unit 34Aa, an inverse quantizing unit 34Ab, an inverse DCT unit 34Ac, an adder 34Ad, and a motion compensation predicting unit 34Ae. When a video signal encoded in MPEG format is input, the video signal is decompressed in response to the above compression process based on the control signal output by the system control unit 21, and decompressed signal So is generated and output to the D/A converter 32.

The video processing apparatus 100A of the present variation encodes a video signal (video content) input from an external input pin INTP or the television receiver of the video recording apparatus 1A using the MPEG decoder processing unit 14A, and inputs this, or uses the de-multiplexer 36 to input a video signal generated by the optical disc 200 (before being decoded by the MPEG decoder processing unit 34A), making it possible to detect subtitles included in the input video signal. The video processing apparatus 100A can further input signals related to detected subtitle data to the system control unit 21 and record these signals together with video signals and audio signals to the optical disc 200, and can output these signals directly to the exterior through a subtitle data output pin EXTT.

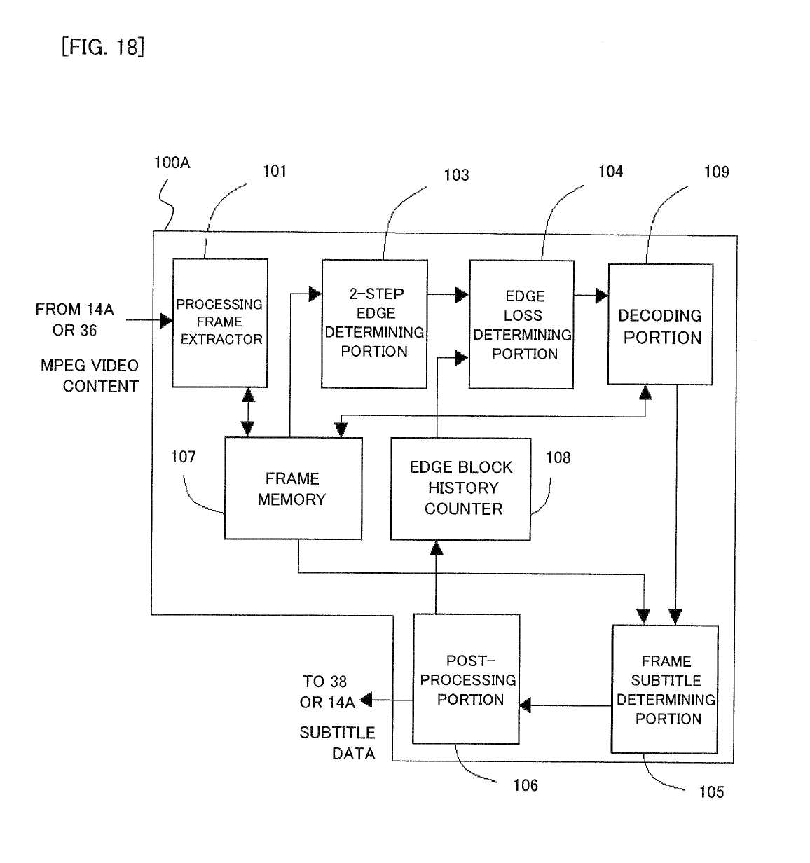

FIG. 18 is a functional block diagram showing an overall functional configuration of the video processing apparatus 100A according to the present variation, and corresponds to FIG. 3 of the above embodiment. The same reference numerals are given to the same parts in FIG. 3, and the description is abbreviated or omitted as appropriate. In FIG. 18, the video processing apparatus 100A differs from the video processing apparatus 100 of the above embodiment in that the pre-processing unit 106 is omitted, and a decoding unit 109 has been newly provided, related to the fact that input is video data in MPEG format.

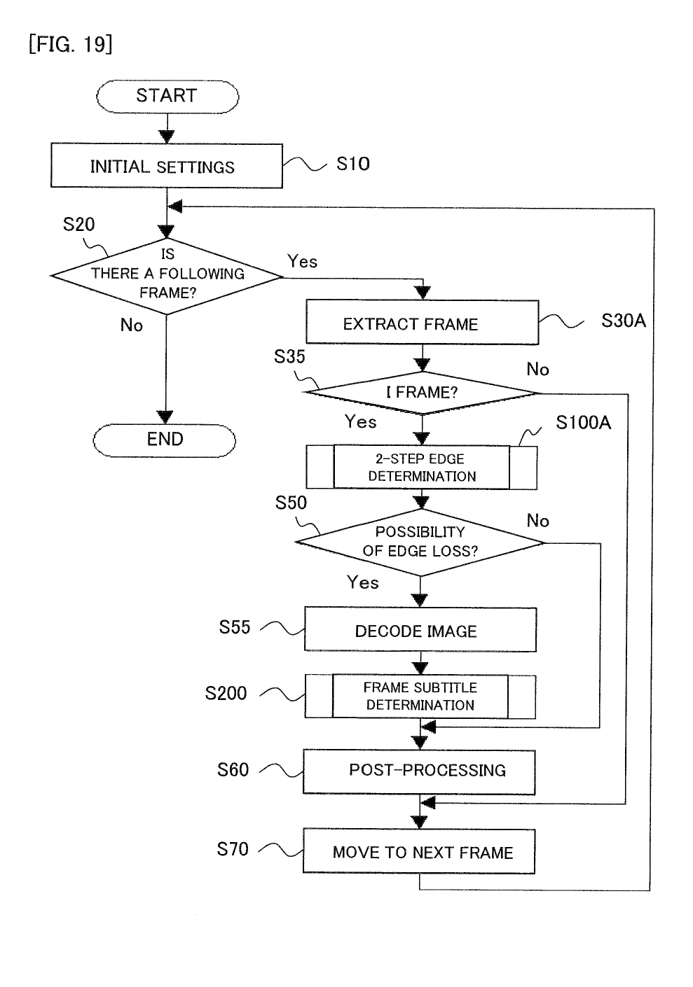

FIG. 19 is a flowchart showing a processing procedure executed by functional units in the video processing apparatus 100A shown in FIG. 18, and corresponds to FIG. 4. In FIG. 19, as in FIG. 4, initial settings are made in step S10, a determination as to whether following frames are present is made in step S20, while input of MPEG-format video content continues, and the procedure enters the loop from step S30A to step S70.

Step S30A corresponds to step S30 in FIG. 4, the processing frame extracting unit 101 extracts data of the frame currently being processed, and stores it in the frame memory 107. Thereafter, the procedures moves to the newly added step S35, and the processing frame extracting unit 101 determines whether or not the frame extracted in step S30A is an I-frame (put another way, whether it is not a P frame or a B frame). If it is a P-frame or a B-frame, the determination is not satisfied, the process moves to step S70 described below, moving to the next frame, and the procedure returns to step S20 and repeats. If it is an I-frame, the determination in step S35 is met, and the procedure moves to step S100A, which corresponds to step S100 in the above embodiment.

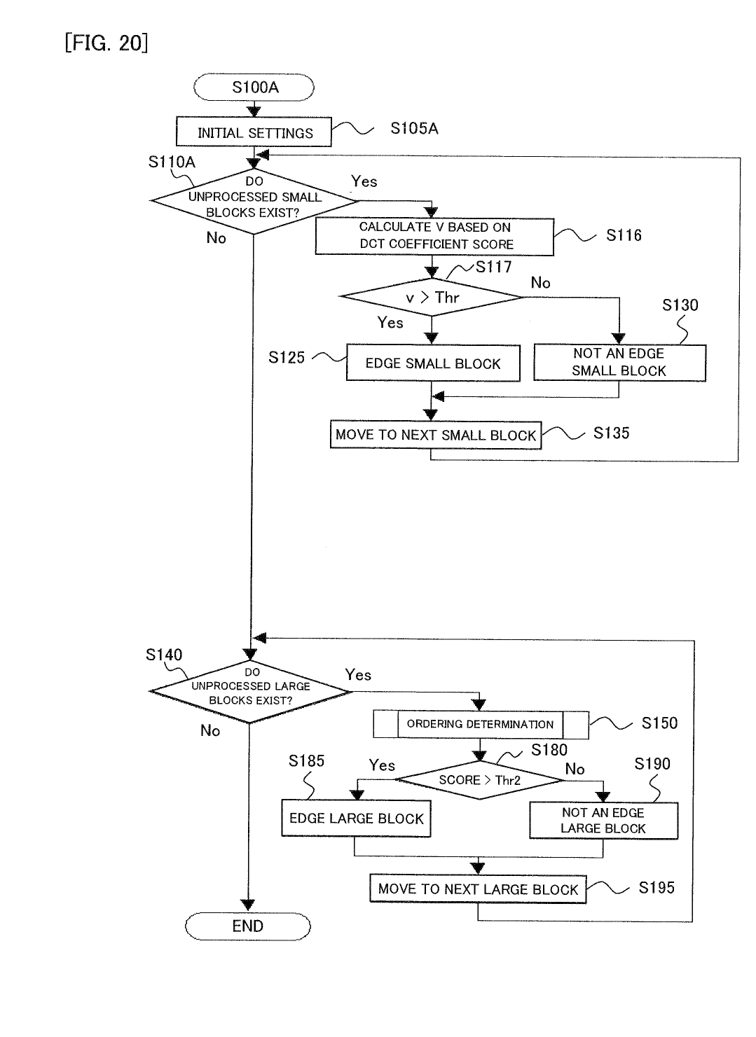

FIG. 20 is a flowchart showing a detailed procedure for step S100A executed by the two-step edge determining unit 103. In FIG. 20, in step S105A corresponding to step S105 in FIG. 5, first, as an initial setting, the entire frame is divided into small blocks, which are small areas. In this example, one block is set to an area of 8×8 pixels, corresponding to an MPEG “block,” thereby creating a one-to-one correspondence between the MPEG blocks in the video data and the small blocks in the subtitle detection process. Edge small block rows for writing the determination results of small blocks and edge area rows for writing the determination results of large blocks are prepared, and each element is initialized. The focus position of the small blocks and the large blocks is set to the top left corner of the screen.

Thereafter, the procedure moves to step S110A, corresponding to step S110 in FIG. 5, and a determination is made as to whether or not any unprocessed small blocks are present. Since there are unprocessed small blocks present, this determination is satisfied, and procedure enters the loop from step S116 to step S135, and the processes of this loop are repeated, returning from step S135 to step S110A, until all the small blocks are processed, and there are no longer any unprocessed small blocks.

In the newly added step S116, a score v for “subtitle-ness” is calculated for a small block based on a DCT coefficient (for example, such as is generated by the (luminance component of the) DCT unit 14Ab of the MPEG encoder processing unit 14A shown in FIG. 17A) for the MPEG block corresponding to that small block. The method for calculating the subtitle-ness score v from the DCT coefficient is, for example, giving a higher weight to the 63 DCT coefficients present in a single MPEG block (8×8=64, minus the direct current component=63) a higher score for a higher frequency, and making the absolute value thereof the score v. A higher score v is thus given to blocks having more edges (or greater edge density) and a higher frequency.

Thereafter, the procedure moves to newly added step S117 and makes a determination as to whether or not the subtitle-ness score v exceeds the prescribed threshold value Thr. Since the score v and the amount of edges are strongly correlated, as described above (in this sense, this determination is one aspect of aspect determination, and is included in a broad sense in the “edge determination” of this specification), if the score v exceeds the threshold value Thr, the determination in step S117 is satisfied, the small block is deemed to be an edge small block with many edges, the procedure moves to step S125 as in FIG. 5, and a 1 is written to the position for that small block in the edge small block row. If the score v is equal to or smaller than the threshold value Thr1, the determination at step S117 is not satisfied, and the procedure moves to step S130 as in FIG. 5, and 0 is written to the position of that small block in the edge small block row. It is sufficient for an appropriate value to be set in advance for the threshold value Thr.

When step S125 or step S130 is finished, the procedure moves to step S135 as in FIG. 5, the focus is moved to the next small block, then the same procedure returns to step S110A and repeats.

In this way, the loop from step S110A to step S135 is repeated, and the determination in step S110 is satisfied when all small blocks are processed and no unprocessed small blocks remain. The procedure then moves to step S140 as in FIG. 5. Starting with step S140 the procedure is the same as in FIG. 5, so the description is omitted.

Returning to FIG. 19, once the two-step edge process is finished, the procedure moves to step S50 as in the embodiment above, and the edge loss determining unit 104 determines whether or not there is a possibility of edge loss from the preceding frame to the current frame based on the status of occurrence of areas included in edge areas in previously processed frames but not in edge areas of the current frame, As in the embodiment above. It is sufficient for the determining method to be the same as in the previously described embodiment.

If an edge has been lost and there is a possibility of subtitle loss, the determination in step S50 is satisfied, and the procedure moves to newly added step S55. In step S55, the I-frame which was processed previously by the decoding unit 109 is decoded, and at least a luminance image is generated. Edges are extracted and the image is binarized by threshold determination of absolute values.

Once step S55 is finished, the procedure moves to step S200 as in FIG. 5, and frame subtitle determination is performed. Starting with step S200, the procedure is the same as in the embodiment described above, so the explanation is omitted (the “still edges” in the embodiment are applicable here by reading them as the extracted “edges”).

It is also possible to have at least two already-processed I-frames always continuously saved to the frame memory 107, so when there is a possibility of subtitle loss, a previous I-frame can be decoded by the decoding unit 109 in addition to the preceding I-frame, just in case, to allow extraction of still edges common to both.

In the present variation, step S105A in a control flow executed by the two-step edge determining unit 103 shown in FIG. 20 corresponds to the division setting unit described in the claims for dividing a single frame into a plurality of large blocks, and dividing the large blocks into a plurality of small blocks. Further, step S110A to step S135 corresponds to a primary determining unit for performing primary determination according to a first determination standard for edges (the score v based on the DCT coefficient), and corresponds to a first determining unit for performing a first determination.

With the present variation, the same effect is obtained as with the embodiment described above. Namely, with the video processing apparatus 100A of the present variation, in step S116 and step S117 the two-step edge determining unit 103 performs indirect edge detection in small blocks by scoring using the DCT coefficient, and performs rough determination of the small block as a first step (in this example, making a determination of an edge small block based on whether or not a small block contains many high-frequency components). Thereafter, if the determination is satisfied, it is possible to perform edge determination at high depth by narrowing down to another standard (in this example, whether or not the large block including the edge small block is an edge large block), thereby making it possible to perform edge determination at higher precision. As a result, it is possible to perform subtitle detection (detect areas with greater “subtitle-ness”) accurately and at high precision. Approximately the same effect as with the above embodiment can be obtained in other regards.

Additionally, the following effects are provided. Specifically, it is possible to reduce the amount of processing, including analysis, etc., required for primary determination compared to directly detecting edges present in small blocks as in the embodiment or in variation (1) and performing primary determination according to the amount of edges therein, by performing primary determination on (in other words, indirectly detecting) small blocks using the DCT coefficient taking advantage of the MPEG format.

Since it is possible to perform edge determination including a primary determination and a secondary determination based thereon with the two-step edge determining unit 103 before decoding with the decoding unit 109, it is sufficient to decode video signals which are compressed and encoded only for frames determined to have a possibility of being a subtitle during edge determination. Accordingly, the amount of data processing for decoding can be reduced, compared to decoding all video signals to be determined and performing edge determination and processes thereafter. An effect is also obtained of being able to reduce the capacity of the frame memory 107 since frames which are held are MPEG-format I-frames.

Furthermore, in the present variation, after the determination in step S117 shown in FIG. 20 is satisfied, it is possible to move to newly added step S118 (post-determining unit, not shown) instead of moving immediately to step S125, and perform determination of the presence or absence of motion compensation process (with the motion compensation predicting unit 14Ah of the MPEG encoder 14A), and further with an aspect thereof as a parameter. For example, the procedure investigates in advance whether or not a macro block is performing motion compensation at positions between I-frames, and stores this in the frame memory 107. Then, when an I-frame appears and two-step block determination is performed in step S100A, even if the score v in step 117 is larger than the threshold value Thr and the determination in step S117 is satisfied, if motion compensation has been performed a prescribed number of times or more at the position of the macro block to which belong the blocks corresponding to the small blocks, it is possible to make it so that the determination is not satisfied, the procedure moves to step S130 and not S125, deem that the small block is not an edge small block, and writer 0 to the position for that small block in the edge small block row. In this way even if it is determined that there is a possibility of a subtitle during the primary determination using the DCT coefficient, it is possible to perform detailed post-determination according to the presence or absence of motion compensation and the aspect thereof, etc., and eliminate this, thus making it possible to further improve the precision of subtitle detection. In this case, there is the effect of being able to reduce the data processing amount associated with image analysis by using motion data made into a parameter during encoding to MPEG format.

In the above, the video processing devices 100 and 101A input a video signal input from the external input pin INTP or the television receiver 50 of the video recording devices 1 and 1A, or the video signal played back from the optical disc 200, and detected subtitles contained in the input video signals. However, this is not a limitation, and it is possible also to input playback video signals recorded on hard disc drives or magnetic tape, or further to input streaming video signals from servers (including home servers), computers (including peripheral devices), portable terminals and data terminals (including portable telephone devices), karaoke apparatuses, consumer game devices, and other products handling digital video, via anetwork, not shown. The same effect is obtained even in these cases.

Note that various modifications which are not described in particular can be made according to the present invention without departing from the spirit and scope of the invention.

1-12. (canceled)

13. A video processing apparatus for performing a detection process for subtitles in each of frames in a video signal, comprising a multi-step edge determining unit performs multi-step determination associated with edges, while performing determination of a following step using a determination standard different from a determination standard in a case in which a determination for a previous step was satisfied for one of said frames, wherein said multi-step edge determining unit comprises:
a division setting unit divides one of said frames into a plurality of large blocks, and further divides each large block into a plurality of small blocks;
a first determining unit performs a first determination for each of said plurality of small blocks according to a first determination standard associated with edges; and
a second determining unit performs a second determination for each of said plurality of large blocks according to a second determination standard associated with the presence of the small blocks; wherein
said multi-step edge determining unit performs said multi-step determination associated with edges according to results of said first determination by said first determining unit and results of said second determination by said second determining unit.

14. The video processing apparatus according to claim 13, wherein:
said first determining unit is a primary determining unit performs a primary determination of each of said plurality of small blocks as said first determination according to said first determination standard; and
said second determining unit is a secondary determining unit performs a secondary determination for each of said plurality of large blocks as said second determination according to said second determination standard associated with small blocks for which a determination was satisfied by said primary determining unit.

15. The video processing apparatus according to claim 14, wherein said primary determining unit performs said primary determination according to an amount of edges present in said small blocks being determined, as said first determination standard.

16. The video processing apparatus according to claim 14, wherein said primary determining unit performs said primary determination according to a DCT coefficient of said small blocks being determined within each frame of said video signal compressed and encoded based on MPEG format, as said first determination standard.

17. The video processing apparatus according to claim 16, wherein said primary determining unit comprises a post-determining unit for performing post-determination according to the presence or absence and condition of a motion compensation process with regard to small blocks for which said primary determination was satisfied.

18. The video processing apparatus according to claim 14, wherein said secondary determining unit performs said secondary determination according to the number of said small blocks for which said primary determination was satisfied, present in said large block being determined, as said second determination standard.

19. The video processing apparatus according to claim 14, wherein said secondary determining unit performs said secondary determination according to a substantially linear continuity of said small blocks for which said primary determination was satisfied, present in said large block being determined, as said second determination standard.

20. The video processing apparatus according to claim 13, comprising a flatness determining unit performs, for one of said frames, determination associated with the presence of flat areas in which pixels with substantially equal luminance or color difference compared with the vicinity are continuous.

21. The video processing apparatus according to claim 21, wherein:
said flatness determining unit comprises a grouping unit groups a plurality of said flat areas included in one of said frames according to the nearness of typical luminance values thereof,
said flatness determining unit performs determination according to characteristic values associated with said flat areas for each group grouped by said grouping unit.

22. The video processing apparatus according to claim 21, wherein said flatness determining unit performs determination according to at least one of a width occupied in said frames by said flat areas, a number of said flat areas, or a position of said flat areas, as a characteristic value associated with said flat areas.

23. A video processing method performs a detection process for subtitles in each of the frames of a video signal, when performing multi-step determination associated with edges while performing determination of a following step using a determination standard different from a determination standard in a case in which a determination for a previous step was satisfied for one of the frames, executing:
a step for dividing one of said frames into a plurality of large blocks, and further dividing each large block into a plurality of small blocks by a division setting unit;
a step for performing a first determination for each of said plurality of small blocks according to a first determination standard associated with edges by a first determining unit;
a step for performing a second determination for each of said plurality of large blocks according to a second determination standard associated with the presence of said small blocks by a second determining unit; and
a further step for performing multi-step determination associated with edges according to results of said first determination by said first determining unit and results of said second determination by said second determining unit.
